(19) United States
(12) Patent Application Publication
(10) Pub. No.: US 2025/0182207 A1
(43) Pub. Date: Jun. 5, 2025

(54) CONSTRAINED OFFER GENERATION

(71) Applicant: STRIPE, INC., South San Francisco, CA (US)

(72) Inventors: Jun Wen, Charlotte, NC (US); Simon Wong, New York, NY (US); Varun Srinivasan, New York, NY (US); Will Burleson, New York, NY (US); Mike Dettmar, New York, NY (US); Bo Xu, Dublin, CA (US); Rockwell Weiner, New York, NY (US); Brian Slakter, New York, NY (US); Clement Miao, New York, NY (US); Ravi Sankar, Washington, DC (US); Lydia Foo, New York, NY (US); Yulun Sharron Chang, Cedar Grove, NJ (US); Serena Sondhi, New York, NY (US)

(21) Appl. No.: 18/525,053

(22) Filed: Nov. 30, 2023

(51) Int. Cl. G06Q 40/06

(52) U.S. Cl. CPC G06Q 40/06

(57) ABSTRACT

A method according to one embodiment includes: receiving historical transaction data collected by a transaction processing platform for a plurality of merchants; computing, using a machine learning model, parameters of an implied growth ratio distribution for each of the merchants based on features of the corresponding historical transaction data; identifying an offer size and an offer premium for financial offers to be made to the merchants by looking up parameters in a lookup table based on the implied growth ratio distributions, the lookup table being computed based on: a first optimization based on a target yield rate constraint and backtesting on a target loss rate constraint and a target repayment time constraint; and a second optimization based on the target loss rate constraint and backtesting on the target yield rate constraint and the target repayment time constraint; and transmitting the plurality of financial offers to the plurality of merchants.

### BACKGROUND

A portfolio of uncorrelated assets generally provides more predictable investment returns than an individual asset because losses in some investments of the portfolio can be offset by gains in other investments. Accordingly, a portfolio can be constructed to provide a target rate of return based on the choices of individual assets to include in that portfolio.

The above information disclosed in this Background section is only for enhancement of understanding of the present disclosure, and therefore it may contain information that does not form the prior art that is already known to a person of ordinary skill in the art.

### SUMMARY

The present disclosure is directed to techniques for constrained offer generation, substantially as shown in and/or described in connection with at least one of the figures, as set forth more completely in the claims.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a schematic depiction of a process for determining loan offers to make to merchants based on historical transaction of those merchants using a payment transaction processing platform according to one embodiment of the present disclosure.

FIG. 2 is a flowchart of a method for determining loan offers to make to merchants based on historical transaction of those merchants using a payment transaction processing platform according to one embodiment of the present disclosure.

FIG. 3 is a graph depicting an example of an implied growth ratio density distribution of a merchant computed by a trained implied growth ratio model according to one embodiment of the present disclosure.

FIG. 4 is a flowchart depicting a method for generating a normalized marginal expected net present value (NMENPV) table according to one embodiment of the present disclosure.

FIG. 5 is a block diagram illustrating a high-level network architecture of a computing system environment for operating a processing system according to embodiments of the present disclosure.

FIG. 6 is a block diagram illustrating a representative software architecture, which may be used in conjunction with various hardware architectures as described herein.

FIG. 7 is a block diagram illustrating components of a processing circuit or a processor, according to some example embodiments, configured to read instructions from a non-transitory computer-readable medium (e.g., a non-transitory machine-readable storage medium) and perform any one or more of the methods discussed herein.

### DETAILED DESCRIPTION

In the following detailed description, only certain exemplary embodiments of the present invention are shown and described, by way of illustration. As those skilled in the art would recognize, the invention may be embodied in many different forms and should not be construed as being limited to the embodiments set forth herein. Like reference numerals designate like elements throughout the specification.

Constructing a portfolio of assets such as loan products involves analyses of risks and expected returns. These analyses may affect decisions about which prospective customers to send loan offers to and the terms of those loan offers, such as loan size (principal or advance amount) and interest (or interest rate or loan fee or premium).

Lending to a business may involve a manual review of information provided by the business, such as tax filings, bank statements, proof of current assets and liabilities, and the like. Based on this collected information, a lender (e.g., a banker) may analyze the financial risk associated with a borrower to determine whether to make a loan and, if so, the terms of such a loan. These loan writing processes are labor-intensive and limits the ability of businesses to access funds to help them grow. In addition, business that are light in capital assets (e.g., to secure loans) or that lack a multi-year track record of cash flows, may also fail to fit the pattern of businesses that can be analyzed by these manual review processes and therefore may also fail to obtain approval for loans.

Aspects of embodiments of the present disclosure relate to systems and methods for constrained offer generation for offering loans to businesses based on their transaction revenue history. In more detail, a business (which may also be referred to herein as a merchant) may use a payment transaction processing platform offered by a payment processing service to handle payments received from the merchant's customers.

For example, a merchant may operate one or more websites to offer goods and/or services. A customer may purchase these goods and services by interacting with a website, such as by adding the desired products to a virtual shopping cart and proceeding through a checkout process. During this checkout process, the customer may provide payment information, such as credit card or debit card information, bank account direct transfer information, checking account information, mobile payment service information (e.g., PayPal®, Venmo®, AliPay®, WeChat Pay®, Apple Pay®, and the like), and the like. The wide range of ways in which a customer may want to pay the merchant can be overwhelming. In addition, security and privacy requirements may be onerous for the merchant to implement, especially when the merchant is a small or medium-sized business that may lack the resources to employ a large software development team and data management team.

A payment transaction processing platform offered by a payment processing service can alleviate these burdens of integrations with a wide variety of payment providers (e.g., different credit card and debit card networks, different mobile payment services, and the like) and can also handle the data management aspect to protect the security of the customer data. In some cases, payment processing services can provide fraud protection or analysis on top of the payment transaction processing platform.

Without the use of such a payment transaction processing platform, information regarding sales transactions may be spread between credit card processors associated with different credit card networks (e.g., Visa®, MasterCard®, and American Express®), different mobile payment services, and banks (e.g., processing personal checks). This makes it difficult to capture a complete picture of a merchant's revenue.

On the other hand, a payment transaction processing platform offered by a payment processing service has access to all of the information regarding the merchants' sales transactions that are processed through that service, across all of the different payment methods supported by the payment processing service.

Accordingly, aspects of embodiments of the present disclosure relate to using the detailed information regarding a merchant's transaction history, as well as current transactions in real-time, to predict future revenue growth of the merchant. Some aspects of embodiments of the present disclosure further relate to using the predicted revenue growth of the merchant to generate customized loan offers to the merchant. The loan offers may be further customized such that a collection of loan offers made and accepted during a time period (e.g., one day) match target characteristics (e.g., target yield, target repayment time, and target loss rate) of a portfolio of loans, such that the portfolio of loans matches the investment goals when financing the portfolio.

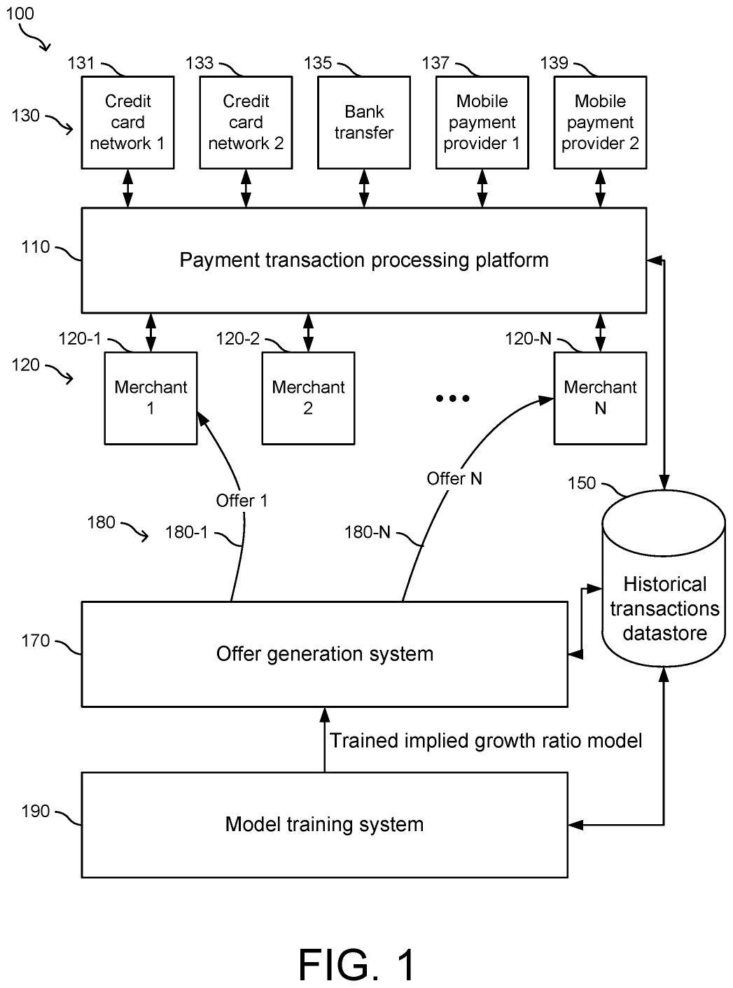

FIG. 1 is a schematic depiction of a system 100 for determining loan offers to make to merchants based on historical transaction of those merchants using a payment transaction processing platform according to one embodiment of the present disclosure.

As shown in FIG. 1, a payment transaction processing platform 110 offers payment transaction processing services to various merchants 120, where the payment transaction processing platform provides these merchants 120 with access to different payment types offered by different payment providers 130. In the example shown in FIG. 1, the payment providers 130 include a first credit card network 131 (e.g., Visa®), a second credit card network 132 (e.g., MasterCard®), a bank transfer 135 (e.g., automated clearing house or ACH), a first mobile payment provider 137 (e.g., PayPal®), and a second mobile payment provider 139 (e.g., WeChat Pay®). These are merely illustrative examples and other payment providers of different types, such as payment providers that offer buy now pay later (BNPL) arrangements, direct connections to banks (e.g., other than ACH transfers), electronic checks, and the like may also be supported by the transaction processing platform.

For the sake of discussion, the merchants 120 are labeled 120-1 through 120-M. These merchants 120 sell goods and services to their customers, who make payments to the merchants 120 using the payment transaction processing platform 110. For example, the payment transaction processing platform 110 may provide an application programming interface (API) such that a website, mobile application, card credit card reader or terminal, or the like that is operated by the merchant can access the payment transaction processing platform 110 to accept payment from the customer. As a specific example, a merchant may operate a website where a checkout web page on the website includes an integrated widget or component of the web page that includes a form for a customer (e.g., a user accessing the website using a web browser) to enter payment information. This interactive widget or component may allow a user to choose a payment type (e.g., credit card, mobile payment provider, bank transfer, or the like) and enter information associated with that payment in the interactive widget or component. The information is then transmitted to the payment transaction processing platform 110, which may record the information (as appropriate and as compliant with data storage requirements imposed by local laws and agreements with the payment providers) and supplies the collected information to the appropriate payment provider 130 for processing. The payment provider may approve or deny the payment, and an appropriate response (e.g., transaction successful or transaction denied) is returned to the merchant 120, which can then present the appropriate response to the customer through the website (e.g., “payment declined, please try again” or “transaction completed”).

In the process of processing payment transactions for merchants 120 through the payment providers 130, the payment transaction processing platform 110 may also store a historical record of transactions (historical transactions) completed for each of the merchants. This record may be stored in a database or datastore of historical transactions 150. For example, each record of a transaction may include a date, a time, an amount, an indication of whether the transaction was successful (e.g., approved by the payment provider), an indication of whether the transaction was later revoked (e.g., canceled or where the merchant issued a refund), and the like. Accordingly, when most or all of given merchant's transactions are processed by the payment transaction processing platform 110, the datastore of historical transactions contains highly detailed information regarding the revenue of that merchant.

As noted above, the payment transaction processing platform 110 may also provide additional services to merchants. For example, the historical transactions datastore 150 may provide information for detecting unusual patterns of behavior and mark transactions as being suspected fraudulent activity. Another example of additional services relate to loan offers to merchants, as computed based on the historical transactions for each of the merchants 120 available in the historical transactions datastore 150, according to some embodiments of the present disclosure.

Aspects of embodiments of the present disclosure will be presented in the context of a loan offer that includes an advance amount or principal (e.g., $10,000) that is charged with a premium or interest (e.g., $1,000). The borrower is obligated to repay a total obligation that is the sum of the advance amount and the premium (e.g., $10,000+$1,000=$11,000). In this example loan product, a loan management platform controls the payment transaction processing platform to automatically withhold a percentage of the revenue received by the merchant (a withhold rate) as repayment until the total obligation is met. Continuing the above example, if a given merchant had revenue of $5,500 per week and the withhold rate was 5%, then the payment transaction processing platform would withhold up to $275 every week until the total obligation of $11,000 was met. In this example scenario, the repayment period would be 40 weeks ($11,000/$275 per week=40 weeks).

Repayments based on a percentage of revenue can be preferable for some merchants, such as merchants who may have seasonal or uneven revenue streams, such that loan repayment costs are lower when business is slow, and loan repayment costs are higher when business is good. While aspects of embodiments of the present disclose will be described in the context of the loan arrangement using withholding described above, embodiments of the present disclosure are not limited thereto and are also applicable to other arrangements or structures of loans.

Multiple loans can be bundled into portfolios of loans for financing. Different financing options may have different preferences with respect to the characteristics of the business loans. These characteristics include target yield or internal rate of return (IRR) or premium rate p*, target repayment time b, and target loss rate e.

Aspects of embodiments of the present disclosure relate to generating loan offers to merchants such that a portfolio of loans corresponding to accepted loan offers meet some initial input set of characteristics. Aspects of embodiments of the present disclosure also relate to techniques to computing a maximum total loan amount that satisfies the input set of characteristics. This may be represented as:

$${max}_{\{ {T}_{i} \}} {\sum }_{i = 1}^{N} {T}_{i} s . t . {\sum }_{i = 1}^{N} \frac{{T}_{i}}{1 + {p}_{i} ( E ( {L}_{i} ( {T}_{i} ) \vert {V}_{i} )} \leq {\sum }_{i = 1}^{N} [ E ( {Q}_{i} ( {T}_{i} , r ) \vert {V}_{i} ) + E ( {D}_{i} ( {T}_{i} , r ) \vert {V}_{i} ) ] \qquad ( 1 )$$

$${\sum }_{i = 1}^{N} E ( {L}_{i} ( {T}_{i} ) \vert {V}_{i} ) / {\sum }_{i = 1}^{N} {T}_{i} \leq e \qquad ( 2 )$$

$${\sum }_{i = 1}^{N} ( E ( {B}_{i} ( {T}_{i} ) \vert {V}_{i} ) \cdot {T}_{i} ) / {\sum }_{i = 1}^{N} {T}_{i} \leq b \qquad ( 3 )$$

where Equation (1) represents the total yield rate constraint, Equation (2) represents the loss rate constraint, and Equation (3) represents the repayment time constraint. In the above equations, Tᵢ is the total obligation (advance amount+premium) for merchant i before any risk policy adjustments, and assumes N merchants. Vᵢ is the future revenue volume for merchant i and is a random variable on which the expectations E are calculated. pᵢ is the premium rate for merchant i and is a function of expected losses Lᵢ as a function of total obligation Tᵢ given the future revenue volume Vᵢ:pᵢ(E(Lᵢ(Tᵢ)|Vᵢ).

As shown above, during the computation, the offer generation system 170 identifies parameters to satisfy a loss rate constraint, a target yield or internal rate of return (IRR) constraint, and a repayment time constraint.

Considering the left-hand side of Equation (1) representing the IRR constraint, an initial investment on a loan to a given merchant is the advance amount, which is the total amount Tᵢ divided by 1 plus the premium rate pᵢ(E(Lᵢ(Tᵢ)|Vᵢ). The total initial investment is the sum of the investment per-merchant (over all N merchants). Considering the right-hand side of Equation (1), Qᵢ is the present value from withholds, computed as a function of the total obligation Tᵢ and discounted by a discount rate r in accordance with the time value of money (Qᵢ(Tᵢ,r)). The expected present value of the withholds is subject to the merchant's future revenue volume Vᵢ:E(Qᵢ(Tᵢ,r)|Vᵢ). In some loan arrangements, when the merchant's revenue during a payment period is less than some minimum amount (e.g., if the revenue for the week multiplied by the withholding rate is less than a threshold value), then any difference between the withheld amount and the minimum amount is debited from a merchant's bank account as Dᵢ(Tᵢ,r), which is also discounted by a discount rate r (Dᵢ(Tᵢ,r)). The expected present value of the bank debits is subject to the merchant's future revenue volume Vᵢ:E(Dᵢ(Tᵢ,r)|Vᵢ). This total expected repayments from the merchants should be greater than or equal to the total obligations of the merchants, after accounting for losses, as represented by the left-hand side of Equation (1).

Referring to the loss rate constraint in Equation (2), E(Lᵢ(Tᵢ)|Vᵢ) is the expected loss given merchant i's total obligation Tᵢ and future revenue volume Vᵢ, and e is the target loss rate specified as an input characteristic (e.g., 10%).

The repayment time constraint in Equation (3) specifies the target average time for the loan to be repaid (e.g., 52 weeks). The expected repayment time B, (e.g., in units of weeks) for merchant i to pay its total obligation Tᵢ(E(Bi(Tᵢ))) is computed subject to future revenue volume Vᵢ of that merchant i. The impact of each merchant on the overall repayment time of the portfolio is weighted by the corresponding size of that merchant's total obligation Tᵢ within the loan portfolio.

As will be discussed in more detail below, different ones of these constraints will be binding depending on merchant characteristics and underwriting strategies. Therefore, as will be discussed in more detail below, aspects of embodiments of the present disclosure relate to performing one optimization based on the target yield rate constraint, then checking whether the target loss and target repayment time constraints are met (e.g., through backtesting), as well as performing another optimization based on the target repayment time constraint, then checking whether the target yield and target repayment time constraints are met (e.g., through backtesting).

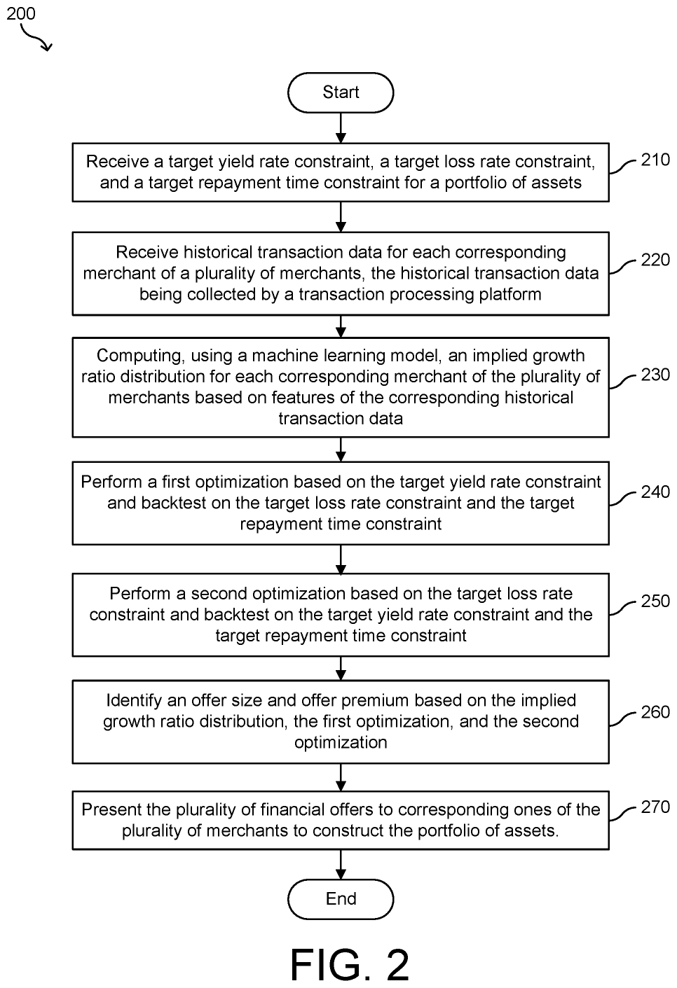

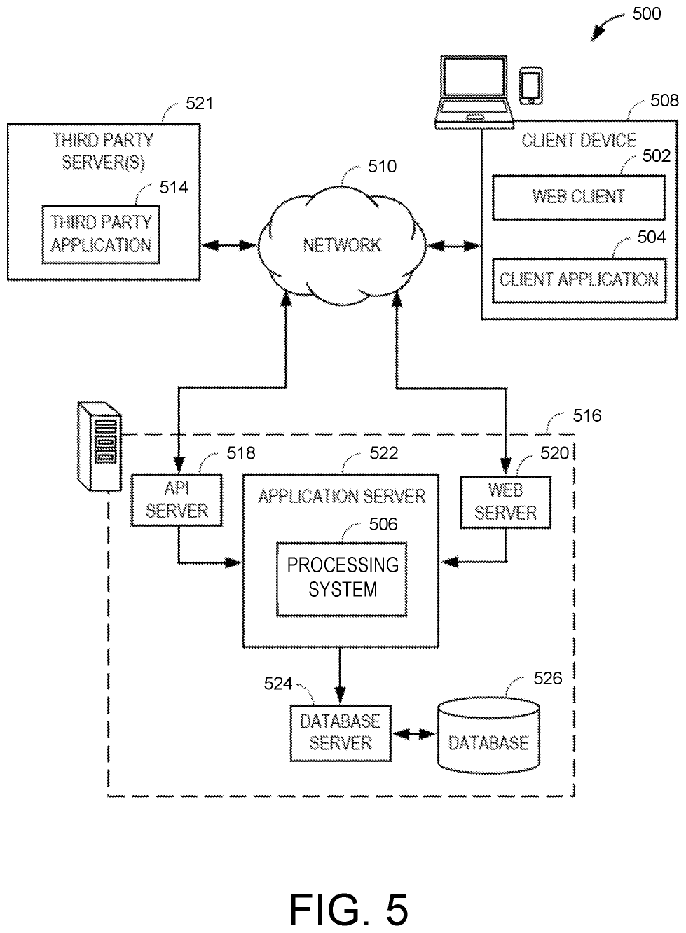

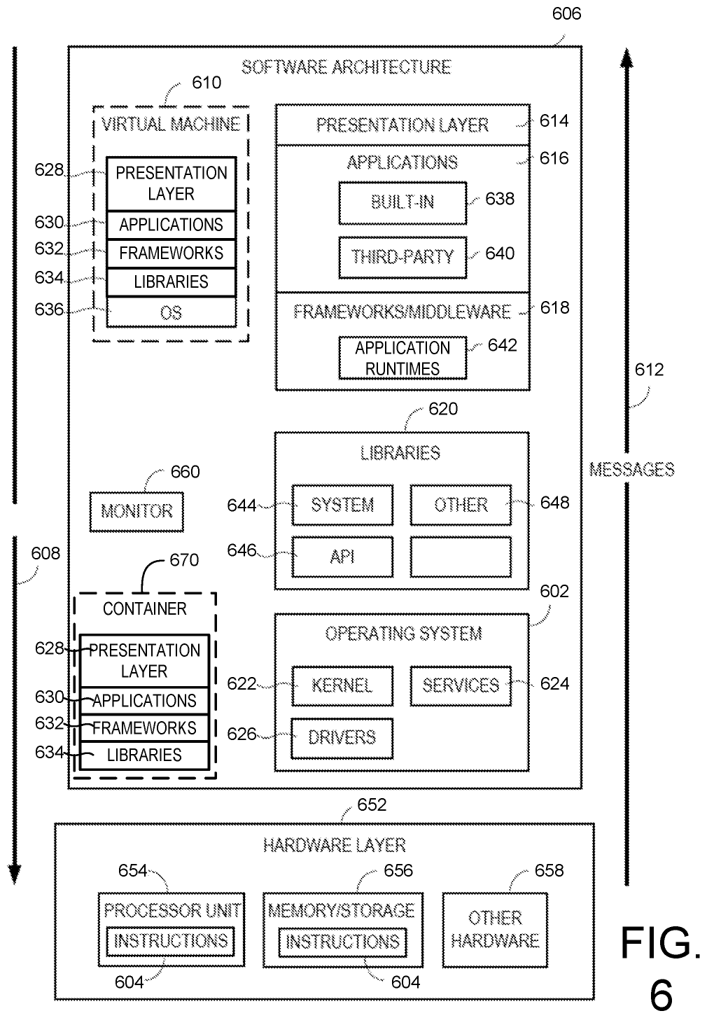

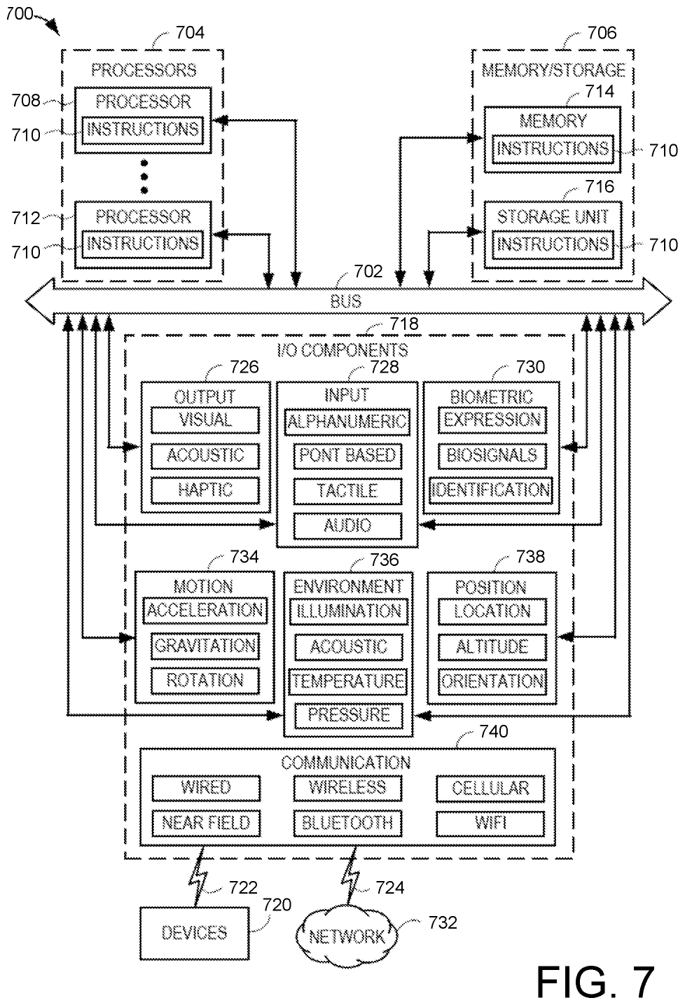

FIG. 2 is a flowchart of a method 200 for determining loan offers to make to merchants based on historical transaction of those merchants using a payment transaction processing platform according to one embodiment of the present disclosure. The method may be implemented by an offer generation system implemented using instructions stored on non-transitory computer-readable media and executed by computer systems such as those described below with respect to FIG. 5, FIG. 6, and FIG. 7. At 210, the offer generation system 170 receives a target yield rate constraint, a target loss rate constraint, and target repayment time constraint for a portfolio of loan assets to be constructed. The offer generation system 170 generates loan offers 180 that may be made to selected ones of the merchants (and may decline to make offers to some merchants, noting that a first offer (Offer 1) 180-1 is made to Merchant 1 120-1 and another offer (Offer N) is mode to Merchant N 120-N, but no offer is made to Merchant 2 120-2 (e.g., because no such loan offer can be made to Merchant 2 that would satisfy the target characteristics of the loan portfolio).

As shown in Equation (1) relating to the IRR or target yield rate constraint, Equation (2) relating to the loss rate constraint, and Equation (3) relating to the repayment time constraint discussed above, computed the expected values of yield, loss, and repayment time for a given merchant i depends on the random variable Vᵢ relating to the future revenue volume of that merchant. The future revenue volume Vᵢ of a merchant i may change over time, due to growth or decline in their businesses based on microeconomic trends (e.g., changes in business strategy) and/or macroeconomic trends (e.g., changes in local economic activity).

Aspects of embodiments of the present disclosure relate to using a machine learning model to compute an implied growth ratio for merchants based on their historical transaction data and other features of those merchants. This implied growth ratio is used to model the future revenue volume Vᵢ of a merchant, which is then used to compute a loan size and premium for that merchant that would meet the target yield rate constraint, target loss rate constraint, and target repayment time constraint (e.g., that has a high likelihood of satisfying those constraints, such as having an expected yield exceeding the target yield rate constraint, an expected repayment time near the target repayment time, and an expected loss less than the target loss rate constraint).

In more detail, the implied growth ratio of a merchant can impact the yield, the repayment time, and the expected loss associated with a loan to that merchant. The above example assumed that the merchant had no revenue growth over the repayment period (e.g., the weekly revenue was assumed to be fixed at $5,500). However, if the merchant's weekly revenue grew while there was a balance on the loan, then the expected repayment time would be shorter than 40 weeks (e.g., because the size of subsequent repayments would be greater). As such, increasing the size of total obligation in accordance with the implied growth ratio can, for example, increase the expected repayment time to be closer to a target repayment time. Likewise, if the merchant's weekly revenue shrank over that time period, then the repayment time would be longer than 40 weeks. As such, reducing the size of the total obligation can, for example, shorten the expected repayment time to be closer to the target repayment time. Processes for identifying an offer size and offer premium will be discussed in more detail below.

At 220, the offer generation system 170 retrieves historical transaction data for each corresponding merchant of a plurality of merchants, the historical transaction data being collected by a payment transaction processing platform. In some embodiments of the present disclosure, the merchants are prescreened based on evaluations of the credit risks associated with these merchants. This prescreening may be performed using a trained machine learning model (a credit model) trained to perform these credit risk evaluations based on features extracted from information about the merchants (e.g., based on their historical transaction data). In some embodiments, the prescreening may be performed, in part, based on satisfying a minimum bank account balance for merchants that have connected their bank accounts to the payment transaction processing platform (e.g., to receive the payments from the customers after the payments are processed by the payment providers and the payment transaction processing platform and after deducting fees charged by the payment providers and the payment transaction processing platform).

At 230, the offer generation system 170 computes an implied growth ratio for each corresponding merchant of the plurality of merchants, using a trained machine learning model, based on features of the corresponding historical transaction data.

In the model training process, various training features are extracted from merchant data (data regarding the merchants themselves) and historical transaction data associated with the merchants. Examples of these features include: payment processing features such as transaction volumes; merchant customer activities such as transaction interactions between a merchant with its customers; and the like.

The model training system 190 trains a machine learning model such as a boosted decision trees machine learning model (e.g., extreme gradient boosting or XGBoost) to predict parameters of statistical distributions to compute probabilistic distributions of implied growth ratios of merchants. In various embodiments of the present disclosure, the machine learning model may include other models that can predict distribution parameters, such as: a generalized additive model for location, scale and shape (GAMLSS), which uses generalized parametric linear models to fit each distributional parameter instead of boosting; distributional random forests, which use trees to estimate distributional parameters in each leaf, which are then averaged across the model; and deep ensembles, which fit an ensemble of neural networks to the dataset and obtain predictive uncertainty by making an approximation to the Gaussian mixture arising out of the ensemble.

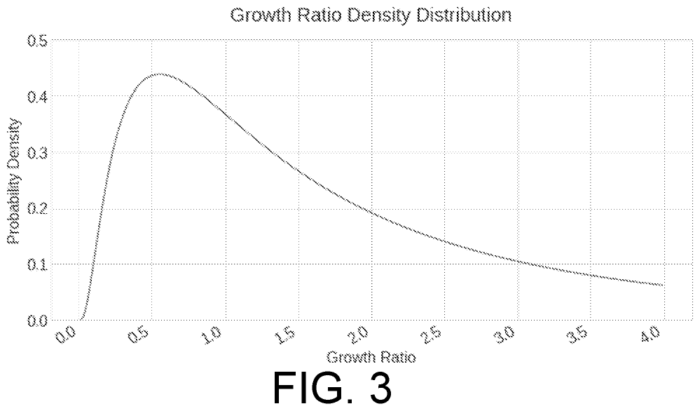

FIG. 3 is a graph depicting an example of an implied growth ratio density distribution of a merchant computed by a trained implied growth ratio model according to one embodiment of the present disclosure. The implied growth ratio density distribution for a merchant represents the distribution of the ratio between the merchant's average weekly volume in the next twelve months and the merchant's average weekly volume in the previous twelve months. (In various embodiments other periods may be used instead of 12 months, where the seasonality or periodicity of the features are controlled.)

A growth ratio of 1.0 indicates no revenue growth, a growth ratio greater than 1.0 indicates growth in the merchant's revenue, and a growth ratio less than 1.0 indicates a decrease in the merchant's revenue. FIG. 3 presents the probability density function of the implied growth ratio of a merchant, which can be approximated by probability distributions such as gamma distributions, log normal distributions, and Weibull distributions. These probability distributions may be characterized by two parameters, referred to as a scale parameter and a shape parameter. On the right side of the distribution (having a higher assumed growth ratio), the risk increases because the probability density drops, whereas on the left side of the distribution (having a lower assumed growth ratio), the risk decreases because the probability density increases. For example, it is highly unlikely that a merchant will sustain a 4× growth rate for a long period, and therefore a merchant is less likely to be able to repay a loan size that assumed 4× growth. On the other hand, a loan size that assumed a lower growth rate slightly higher than 1.0 would be a much smaller loan and therefore it would be more likely that a merchant could pay that back. At growth rates lower than 1.0 (e.g., declining revenue), a merchant is also less likely to be able to pay back a loan.

Accordingly, the implied growth ratio model is trained at 350 to compute parameters of distributions (e.g., shape and scale parameters in the case of a gamma distribution, log normal distribution, or Weibull distribution) where the parameters represent the computed probabilistic distributions of the implied growth ratios of various merchants over a time period (e.g., a 12-month period).

In some embodiments of the present disclosure, the model training system 190 uses a gradient boosting training process. In some embodiments, the model training system uses a generalized additive model for location, scale and shape (GAMLSS), which uses generalized parametric linear models to fit each distributional parameter instead of boosting; distributional random forests, which use trees to estimate distributional parameters in each leaf, which are then averaged across the model; and deep ensembles, which fit an ensemble of neural networks to the dataset and obtain predictive uncertainty by making an approximation to the Gaussian mixture arising out of the ensemble.

The result of the training process at 350 is a model that predicts the scale and shape of the distribution for identifying or computing a loan size and premium amount that would satisfy target yield (IRR), target loss rate, and target repayment times, because a merchant's default risk is correlated with its loan size and its future revenue growth ratio (implied growth ratio), as will be described in more detail below.

As noted above, different ones of the three constraints (target yield or IRR, target loss rate, and target repayment time) will be binding in different contexts, such as the characteristics of the merchants in the pool that could receive loan offers and underwriting strategies of the lender. In some embodiments described herein, one of the three constraints is used to perform an optimization to search for values that maximize the target function (the total advance and premium Σᵢ₌₁^{N}Tᵢ), and then performing backtesting to determine whether the computed values satisfy the other two constraints. As will be discussed in more detail below, aspects of embodiments of the present disclosure relate to performing, at 240, one optimization based on the target yield rate constraint, then checking whether the target loss and target repayment time constraints are met (e.g., through backtesting), as well as performing another optimization, at 250, based on the target repayment time constraint, then checking whether the target yield and target repayment time constraints are met (e.g., through backtesting). Embodiments of the present disclosure are not limited to testing the constraints in a particular order. In addition, the constraints may be tested concurrently (e.g., running optimizations corresponding to two different constraints such as optimization based on the target yield rate constraint at 240 and the optimization based on the target loss rate constraint at 250 concurrently on two different processing cores of the offer generation system 170, where the offer generation system 170 may include one or more computers and the different processing cores may be part of a same computer or part of different computers).

At 240, the offer generation system 170 performs a first optimization based on the target yield rate constraint (e.g., Equation (1)) and then backtests on the target loss rate constraint and the target repayment time constraint (e.g., Equations (2) and (3), respectively).

In many circumstances, the target yield rate constraint is expected to be binding when maximizing the target function y (the total amounts of the loans Tᵢ) when only the target yield rate constraint is applied. In circumstances where the target yield rate constraint is not applied, then the loan sizes Tᵢ can be increased to improve the target function y. In some embodiments, Karush-Kuhn-Tucker (KKT) conditions are evaluated in the process of finding a solution to the optimization based on the target yield rate constraint.

The total amount Tᵢ for a merchant i can be normalized as:

Tᵢ=l·wᵢ·vᵢ·tᵢ

where l is the target repayment week (e.g., 52 weeks), wᵢ is the merchant's withhold rate, vᵢ is the merchant's average weekly volume in the past 12 months, and tᵢ is the implied growth ratio given the total amount Tᵢ, where tᵢ is the control variable that is controlled by changing the total amount Tᵢ offered to the merchant.

The marginal net present value of a loan can then be expressed in terms of the marginal expected present value from withholds, the marginal expected present value from debits, and the marginal initial investment:

$$Marginal Expected Net Present Value = Marginal Expected Present Value from Withholds + Marginal Expected Present Value from Debits - Marginal Initial Investment$$

When the target yield is used as the constraint for optimization at 240, the optimization can only be performed if all loans have the same normalized marginal expected net present value (NMENPV), which is expressed as a vector. For example, if two loans had different NMENPV, then funds could be taken from the loan with the lower NMENPV and given to the loan with the higher NMENPV, which would increase the overall net present value and a non-binding constraint. Accordingly, some aspects of embodiments of the present disclosure relate to computing a target NMENPV through backtesting that satisfies all of the constraints.

A closed form solution for the implied growth ratio t does not exist given a target NMENPV. Some aspects of embodiments of the present disclosure relate to generating a lookup table of NMENPV values once during backtesting and using the lookup table to lookup NMENPV values during offer generation based on given scale (γ) and shape (σ) of the implied growth ratio density distribution, debit success probability (d), and implied growth ratio (t).

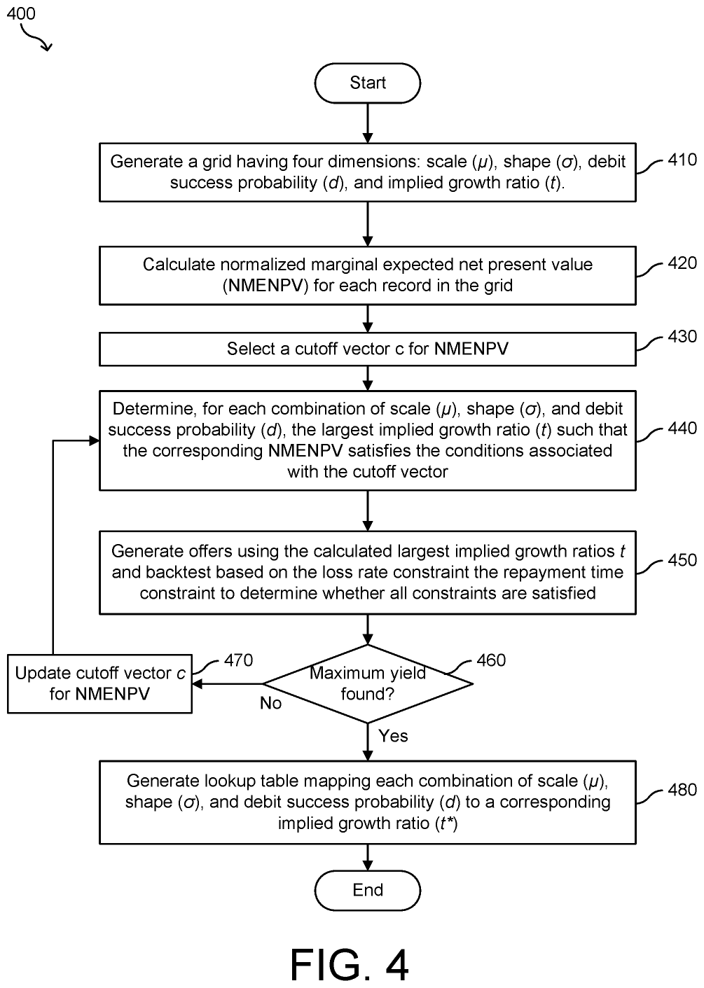

FIG. 4 is a flowchart depicting a method 400 for generating a normalized marginal expected net present value (NMENPV) table according to one embodiment of the present disclosure. The table may be generated by a computer system as described in more detail below, such as by the model training system 190 or the offer generation system 170.

At 410, the computer system generates a grid having four dimensions: scale (in, e.g., [0.01, 5]) and shape (in, e.g., [0.01, 5]) of the implied growth ratio density distribution, debit success probability (d in, e.g., [0.0, 1.0]), and implied growth ratio (t in, e.g., [0.01, 5]), where each interval may spacing of, for example, 0.01. At 420, the computer system calculates a normalized marginal expected net present value (NMENPV) for each record in the grid using the equation given above for NMENPV, using the values of debit success probability d and implied growth ratio t for that location in the grid, and the scale and shape to set the growth ratio g in accordance with the probabilistic model.

At 430, the computer system sets a threshold or cutoff vector c for NMENPV.

At 440, the computer system determines, for each combination of scale of the implied growth ratio density distribution, shape of the implied growth ratio density distribution, and debit success probability (d), the largest implied growth ratio (t) such that the corresponding NMENPV satisfies the conditions associated with the cutoff vector c. The conditions depends on the shape of NMENPV as driven by the pricing formula. For example, the condition is NMENPV≥c for a pricing formula based on risk levels within the credit box.

At 450, the computer system generates offers using the calculated largest implied growth ratios t and backtests based on the loss rate constraint and the repayment time constraint to determine whether all constraints are satisfied.

At 460, the computer system determines whether a maximum yield has been found (e.g., based on whether the current yield is higher than any yield found before during the search). If not, then at 470 the computer system updates the cutoff vector c for NMENPV at 470 and returns to 440 and repeats the process using the updated cutoff vector c, where the updating of the cutoff vector c is performed based on performing a grid search on values of the cutoff vector c, e.g., selecting a next value based on incrementing the previous cutoff vector in accordance with the grid search

When the maximum yield has been found, then at 480 the computer system creates a lookup table mapping each combination of scale, shape, and debit success probability (d) to a corresponding highest implied growth ratio (t*) found at 460.

Accordingly, referring back to FIG. 2, at 240 the offer generation system performs the first optimization subject to the target yield rate constraint using the lookup table to perform the optimization to identify a set of total obligations {Tᵢ} corresponding to the advance amount and premiums of the loan offers to be made to corresponding ones of the merchants. In more detail, the shape and scale values of the distributions (approximated by, e.g., a gamma distribution, a log normal distribution, or a Weibull distribution) of revenue growth ratio gᵢ predicted by the machine learning model at 230 are used to look up nearest values of the highest implied growth ratio tᵢ from the lookup table, as the lookup table may not include an entry for the particular shape and scale pair of a given merchant. The looked-up values of tᵢ from the lookup table are then interpolated (e.g., linearly) to compute the total obligation Tᵢ for that merchant. The results are then backtested against the target loss rate constraint and the target repayment time constraint.

At 250, the offer generation system performs a second optimization based on the target loss rate constraint (Σᵢ₌₁^{N}E(Lᵢ(Tᵢ)|Vᵢ)/Σᵢ₌₁^{N}Tᵢ≤e) and backtests the results based on the target yield rate constraint and the target repayment time constraint. The KKT conditions are evaluated in the process of finding a solution to the optimization based on the target loss rate constraint, where the KKT conditions H are simplified through a Lagrange multiplier λ.

Accordingly, referring back to FIG. 2, at 250 the offer generation system performs the second optimization subject to the target loss rate constraint. The results are then backtested against the target yield rate constraint and the target repayment time constraint.

At 260, the offer generation system 170 identifies an offer size and an offer premium for each merchant based on the first optimization performed at 240 and the second optimization performed at 250 (e.g., after determining which of the results of the optimizations also satisfied the other two constraints as determined by backtesting). For example, in some embodiments of the present disclosure, the premium rate pᵢ that is charged to a merchant i is calculated based on a pricing formula, based on that merchant's expected loss rate ELRᵢ, where the merchant's past revenue and the calculated implied growth ratio tᵢ are used to compute a withheld amount (in accordance with a withholding rate) corresponding to the total amount of the loan Tᵢ, and the premium rate pᵢ is used to compute the advance amount and the premium from the total obligation Tᵢ.

At 270, the offer generation system 170 transmits offers 180 to selected merchants (e.g., based on a business policy, such as merchants whose computed offer size Tᵢ was greater than a threshold value.

Merchants 120 may choose to accept or decline the loan offers 180 that they receive. The offer generation system 170 or other computer systems within the payment processing service receive responses from the merchants 120 regarding the loan offers 180, such as an acceptance of a loan offer or an explicit decline (or an implicit decline of the loan offer due to the expiration of the offer after a time period such as two weeks from the initial transmission of the offer). Acceptance of a loan results in transferring the advance amount to an account associated with the merchant who accepted the loan and configuration of the payment transaction processing platform 110 to implement automatic withholding of funds from transactions incurred by the merchant (e.g., at the agreed-upon withholding rate) for repayment of the loan and automatic debiting of a bank account associated with the merchant in cases where the withheld amounts do not satisfy a minimum repayment amount.

Accepted offers are collected into a portfolio of loans, which has an overall expected yield rate, overall expected loss rate, and overall expected repayment time based on the expected yield rate, expected loss rate, and expected repayment time of the individual loans contained therein, where the offer generation system 170 generated the loan offers based on a target yield rate constraint, a target loss rate constraint, and a target repayment time constraint received at 210.

With reference to FIG. 5, an example embodiment of a high-level SaaS network architecture 500 is shown. A networked system 516 provides server-side functionality via a network 510 (e.g., the Internet or a WAN) to a client device 508. A web client 502 and a programmatic client, in the example form of a client application 504 (e.g., client software for displaying offers to merchants as well as client software on different clients for supplying target loan characteristics), are hosted and execute on the client device 508. The networked system 516 includes one or more servers 522 (e.g., servers hosting services exposing remote procedure call APIs), which hosts a processing system 506 (such as the processing system described above according to various embodiments of the present disclosure
supporting service for automatically processing accounting data) that provides a number of functions and services via a service oriented architecture (SOA) and that exposes services to the client application 504 that accesses the networked system 516 where the services may correspond to particular workflows. The client application 504 also provides a number of interfaces described herein, which can present an output in accordance with the methods described herein to a user of the client device 508.

The client device 508 enables a user to access and interact with the networked system 516 and, ultimately, the processing system 506. For instance, the user provides input (e.g., touch screen input or alphanumeric input) to the client device 508, and the input is communicated to the networked system 516 via the network 510. In this instance, the networked system 516, in response to receiving the input from the user, communicates information back to the client device 508 via the network 510 to be presented to the user.

An API server 518 and a web server 520 are coupled, and provide programmatic and web interfaces respectively, to the servers 522. For example, the API server 518 and the web server 520 may produce messages (e.g., RPC calls) in response to inputs received via the network, where the messages are supplied as input messages to workflows orchestrated by the processing system 506. The API server 518 and the web server 520 may also receive return values (return messages) from the processing system 506 and return results to calling parties (e.g., web clients 502 and client applications 504 running on client devices 508 and third-party applications 514) via the network 510. The servers 522 host the processing system 506, which includes components or applications in accordance with embodiments of the present disclosure as described above. The servers 522 are, in turn, shown to be coupled to one or more database servers 524 that facilitate access to information storage repositories (e.g., databases 526). In an example embodiment, the databases 526 includes storage devices that store information accessed and generated by the processing system 506, such as the persistent store 280 of FIG. 2 and the persistent store 580 of FIG. 5 and other databases such as databases storing information associated with transactions processed by a business.

Additionally, a third-party application 514, executing on one or more third-party servers 521, is shown as having programmatic access to the networked system 516 via the programmatic interface provided by the API server 518. For example, the third-party application 514, using information retrieved from the networked system 516, may support one or more features or functions on a website hosted by a third-party.

Turning now specifically to the applications hosted by the client device 508, the web client 502 may access the various systems (e.g., the processing system 506) via the web interface supported by the web server 520. Similarly, the client application 504 (e.g., an “app” such as a payment processor app) may access the various services and functions provided by the processing system 506 via the programmatic interface provided by the API server 518. The client application 504 may be, for example, an “app” executing on the client device 508, such as an iOS or Android OS application to enable a user to access and input data on the networked system 516 in an offline manner and to perform batch-mode communications between the client application 504 and the networked system 516.

Further, while the network architecture 500 shown in FIG. 5 employs a client-server architecture, the present disclosure is not limited to such an architecture, and could equally well find application in a distributed, or peer-to-peer, architecture system, for example.

FIG. 6 is a block diagram illustrating an example software architecture 606, which may be used in conjunction with various hardware architectures herein described. FIG. 6 is a non-limiting example of a software architecture 606, and it will be appreciated that many other architectures may be implemented to facilitate the functionality described herein. The software architecture 606 may execute on hardware such as a machine 700 of FIG. 7 that includes, among other things, processors 704, memory/storage 706, and input/output (I/O) components 718. A representative hardware layer 652 is illustrated and can represent, for example, the machine 700 of FIG. 7. The representative hardware layer 652 includes a processor 654 having associated executable instructions 604. The executable instructions 604 represent the executable instructions of the software architecture 606, including implementation of the methods, components, and so forth described herein. The hardware layer 652 also includes non-transitory memory and/or storage modules as memory/storage 656, which also have the executable instructions 604. The hardware layer 652 may also include other hardware 658.

In the example architecture of FIG. 6, the software architecture 606 may be conceptualized as a stack of layers where each layer provides particular functionality. For example, the software architecture 606 may include layers such as an operating system 602, libraries 620, frameworks/middleware 618, applications 616 (such as the services of the payment processing system, the offer generation system, and the model training system), and a presentation layer 614. Operationally, the applications 616 and/or other components within the layers may invoke API calls 608 through the software stack and receive a response as messages 612 in response to the API calls 608. The layers illustrated are representative in nature, and not all software architectures have all layers. For example, some mobile or special-purpose operating systems may not provide a frameworks/middleware 618, while others may provide such a layer. Other software architectures may include additional or different layers.

The operating system 602 may manage hardware resources and provide common services. The operating system 602 may include, for example, a kernel 622, services 624, and drivers 626. The kernel 622 may act as an abstraction layer between the hardware and the other software layers. For example, the kernel 622 may be responsible for memory management, processor management (e.g., scheduling), component management, networking, security settings, and so on. The services 624 may provide other common services for the other software layers. The drivers 626 are responsible for controlling or interfacing with the underlying hardware. For instance, the drivers 626 include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 620 provide a common infrastructure that is used by the applications 616 and/or other components and/or layers. The libraries 620 provide functionality that allows other software components to perform tasks in an easier fashion than by interfacing directly with the underlying operating system 602 functionality (e.g., kernel 622, services 624, and/or drivers 626). The libraries 620 may include system libraries 644 (e.g., C standard library) that may provide functions such as memory allocation functions, string manipulation functions, mathematical functions, and the like. In addition, the libraries 620 may include API libraries 646 such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 3D graphic content on a display), database libraries (e.g., SQLite that may provide various relational database functions), and the like. The libraries 620 may also include a wide variety of other libraries 648 to provide many other APIs to the applications 616 and other software components/modules.

The frameworks/middleware 618 provide a higher-level common infrastructure that may be used by the applications 616 and/or other software components/modules. For example, the frameworks/middleware 618 may provide high-level resource management functions, web application frameworks, application runtimes 642 (e.g., a Java virtual machine or JVM), and so forth. The frameworks/middleware 618 may provide a broad spectrum of other APIs that may be utilized by the applications 616 and/or other software components/modules, some of which may be specific to a particular operating system or platform.

The applications 616 include built-in applications 638 and/or third-party applications 640. The applications 616 may use built-in operating system functions (e.g., kernel 622, services 624, and/or drivers 626), libraries 620, and frameworks/middleware 618 to create user interfaces to interact with users of the system. Alternatively, or additionally, in some systems, interactions with a user may occur through a presentation layer, such as the presentation layer 614. In these systems, the application/component “logic” can be separated from the aspects of the application/component that interact with a user.

Some software architectures use virtual machines. In the example of FIG. 6, this is illustrated by a virtual machine 610. The virtual machine 610 creates a software environment where applications/components can execute as if they were executing on a hardware machine (such as the machine 700 of FIG. 7, for example). The virtual machine 610 is hosted by a host operating system (e.g., the operating system 602 in FIG. 6) and typically, although not always, has a virtual machine monitor 660 (or hypervisor), which manages the operation of the virtual machine 610 as well as the interface with the host operating system (e.g., the operating system 602). A software architecture executes within the virtual machine 610 such as an operating system (OS) 636, libraries 634, frameworks 632, applications 630, and/or a presentation layer 628. These layers of software architecture executing within the virtual machine 610 can be the same as corresponding layers previously described or may be different.

Some software architectures use containers 670 or containerization to isolate applications. The phrase “container image” refers to a software package (e.g., a static image) that includes configuration information for deploying an application, along with dependencies such as software components, frameworks, or libraries that are required for deploying and executing the application. As discussed herein, the term “container” refers to an instance of a container image, and an application executes within an execution environment provided by the container. Further, multiple instances of an application can be deployed from the same container image (e.g., where each application instance executes within its own container). Additionally, as referred to herein, the term “pod” refers to a set of containers that accesses shared resources (e.g., network, storage), and one or more pods can be executed by a given computing node. A container 670 is similar to a virtual machine in that it includes a software architecture including libraries 634, frameworks 632, applications 630, and/or a presentation layer 628, but omits an operating system and, instead, communicates with the underlying host operating system 602.

FIG. 7 is a block diagram illustrating components of a machine 700, according to some example embodiments, able to read instructions from a non-transitory machine-readable medium (e.g., a computer-readable storage medium) and perform any one or more of the methodologies discussed herein. Specifically, FIG. 7 shows a diagrammatic representation of the machine 700 in the example form of a computer system, within which instructions 710 (e.g., software, a program, an application, an applet, an app, or other executable code) for causing the machine 700 to perform any one or more of the methodologies discussed herein may be executed. As such, the instructions 710 may be used to implement modules or components described herein. The instructions 710 transform the general, non-programmed machine 700 into a particular machine 700 programmed to carry out the described and illustrated functions in the manner described. In alternative embodiments, the machine 700 operates as a standalone device or may be coupled (e.g., networked) to other machines. In a networked deployment, the machine 700 may operate in the capacity of a server machine or a client machine in a server-client network environment, or as a peer machine in a peer-to-peer (or distributed) network environment. The machine 700 may include, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 710, sequentially or in parallel or concurrently, that specify actions to be taken by the machine 700. Further, while only a single machine 700 is illustrated, the term “machine” or “processing circuit” shall also be taken to include a collection of machines that individually or jointly execute the instructions 710 to perform any one or more of the methodologies discussed herein.

The machine 700 may include processors 704 (including processors 708 and 712), memory/storage 706, and I/O components 718, which may be configured to communicate with each other such as via a bus 702. The memory/storage 706 may include a memory 714, such as a main memory, or other memory storage, and a storage unit 716, both accessible to the processors 704 such as via the bus 702. The storage unit 716 and memory 714 store the instructions 710 embodying any one or more of the methodologies or functions described herein. The instructions 710 may also reside, completely or partially, within the memory 714, within the storage unit 716, within at least one of the processors 704 (e.g., within the processor's cache memory), or any suitable combination thereof, during execution thereof by the machine 700. Accordingly, the memory 714, the storage unit 716, and the memory of the processors 704 are examples of machine-readable media.

The I/O components 718 may include a wide variety of components to receive input, provide output, produce output, transmit information, exchange information, capture measurements, and so on. The specific I/O components 718 that are included in a particular machine will depend on the type of machine. For example, portable machines such as mobile phones may include a touch input device or other such input mechanisms, while a headless server machine will likely not include such a touch input device. It will be appreciated that the I/O components 718 may include many other components that are not shown in FIG. 7. The I/O components 718 are grouped according to functionality merely for simplifying the following discussion, and the grouping is in no way limiting. In various example embodiments, the I/O components 718 may include output components 726 and input components 728. The output components 726 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 728 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and/or force of touches or touch gestures, or other tactile input components), audio input components (e.g., a microphone), and the like.

In further example embodiments, the I/O components 718 may include biometric components 730, motion components 734, environment components 736, or position components 738, among a wide array of other components. For example, the biometric components 730 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 734 may include acceleration sensor components (e.g., accelerometer), gravitation sensor components, rotation sensor components (e.g., gyroscope), and so forth. The environment components 736 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas sensors to detect concentrations of hazardous gases for safety or to measure pollutants in the atmosphere), or other components that may provide indications, measurements, or signals corresponding to a surrounding physical environment. The position components 438 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 718 may include communication components 740 operable to couple the machine 700 to a network 732 or devices 720 via a coupling 724 and a coupling 722, respectively. For example, the communication components 740 may include a network interface component or other suitable device to interface with the network 732. In further examples, the communication components 740 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 720 may be another machine or any of a wide variety of peripheral devices (e.g., a peripheral device coupled via a USB).

Moreover, the communication components 740 may detect identifiers or include components operable to detect identifiers. For example, the communication components 740 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 740, such as location via Internet Protocol (IP) geo-location, location via Wi-Fi® signal triangulation, location via detecting an NFC beacon signal that may indicate a particular location, and so forth.

It should be understood that the sequence of steps of the processes described herein in regard to various methods and with respect various flowcharts is not fixed, but can be modified, changed in order, performed differently, performed sequentially, concurrently, or simultaneously, or altered into any desired order consistent with dependencies between steps of the processes, as recognized by a person of skill in the art. Further, as used herein and in the claims, the phrase “at least one of element A, element B, or element C” is intended to convey any of: element A, element B, element C, elements A and B, elements A and C, elements B and C, and elements A, B, and C.

According to one embodiment of the present disclosure, a method includes: receiving a target yield rate constraint, a target loss rate constraint, and target repayment time constraint for a portfolio of assets; receiving historical transaction data for each corresponding merchant of a plurality of merchants, the historical transaction data being collected by a transaction processing platform; computing, using a machine learning model executed by a computer system including a processing circuit, parameters of an implied growth ratio distribution for each corresponding merchant of the plurality of merchants based on features of the corresponding historical transaction data; identifying, by the computer system, a plurality of financial offers to be made to the plurality of merchants based on the corresponding implied growth ratio distributions, subject to the target yield rate constraint, the target loss rate constraint, and the target repayment time constraint, based on: a first optimization based on the target yield rate constraint and backtesting on the target loss rate constraint and the target repayment time constraint; a second optimization based on the target loss rate constraint and backtesting on the target yield rate constraint and the target repayment time constraint; and identifying an offer size and offer premium for each of the plurality of financial offers based on the corresponding implied growth ratio distribution, the first optimization, and the second optimization; and transmitting the plurality of financial offers to corresponding ones of the plurality of merchants to construct the portfolio of assets.

The computing the plurality of financial offers may include: performing a third optimization based on the target loss rate constraint and backtesting on the target yield rate constraint and the target repayment time constraint.

The method may further include receiving a plurality of offer acceptances in response to the plurality of financial offers, where the portfolio of assets comprises accepted financial offers. An offer acceptance of the plurality of offer acceptance may correspond to a transfer of the offer size corresponding to the accepted financial offer to an account associated with a merchant. The offer acceptance may result in a periodic automatic deduction of a withholding amount from the account associated with the merchant, the withholding amount being computed based on a withholding rate and a revenue of the merchant during a corresponding period.

The machine learning model may be trained based on training transactional data and training growth ratios of merchants.

The identifying the offer size and the offer premium of each of the plurality of financial offers may include: retrieving growth ratios from a lookup table based on the parameters of the implied growth ratio distribution for the corresponding merchant, the lookup table being computed by constructing a grid of growth ratios in accordance with the first optimization and the second optimization; and performing linear interpolation on the growth ratios retrieved from the lookup table.

A training process training the machine learning model may include: extracting, based on training historical transaction data for each of a plurality of training merchants, a plurality of input features for a training merchant of the training merchants and a historical transaction volume growth rate; and computing a probabilistic model based on the plurality of input features and the historical transaction volume growth rate, the probabilistic model being configured to output a distribution of implied transaction volume growth rates for a merchant described by the plurality of input features. The training historical transaction data may be collected by the transaction processing platform.

According to one embodiment of the present disclosure a method includes: extracting, based on historical transaction data for each of a plurality of training merchants, a plurality of input features for a training merchant of the training merchants and a historical transaction volume growth rate; and training a machine learning model based on the plurality of input features and the historical transaction volume growth rate, the machine learning model being trained to output a distribution of implied transaction volume growth rates for a merchant described by the plurality of input features. The training historical transaction data may be collected by the transaction processing platform.

The distribution of implied transaction growth rates may have a distribution parameterized by a shape value and a scale value, wherein the distribution may be selected from a group including: a gamma distribution; a lognormal distribution; and a Weibull distribution.

The machine learning model may include at least one of: a boosted decision tree; a generalized additive model for location, scale and shape; a distributional random forest; and a deep ensemble including a plurality of neural networks.

According to one embodiment of the present disclosure, a non-transitory computer-readable medium stores instructions that, when executed by a computer system including a processing circuit, cause the computer system to: receive historical transaction data for each merchant of a plurality of merchants, the historical transaction data being collected by a transaction processing platform; compute, using a machine learning model, parameters of an implied growth ratio distribution for each corresponding merchant of the plurality of merchants based on features of the corresponding historical transaction data; identify an offer size and an offer premium for each financial offer of a plurality of financial offers to be made to corresponding ones of the plurality of merchants by looking up parameters in a lookup table based on the corresponding implied growth ratio distributions of the merchants, the lookup table being computed based on: a first optimization based on a target yield rate constraint and backtesting on a target loss rate constraint and a target repayment time constraint; and a second optimization based on the target loss rate constraint and backtesting on the target yield rate constraint and the target repayment time constraint; and transmit the plurality of financial offers to the plurality of merchants. The implied growth ratio distribution may include a distribution selected from a group including: a gamma distribution; a lognormal distribution; and a Weibull distribution, and the parameters may include a shape value and a scale value.

The lookup table may map from the shape value and the scale value of the parameters of the implied growth ratio distribution to a growth ratio, and the offer size and the offer premium may be computed based on the historical transaction data. the growth ratio, and an expected loss rate of the merchant.

The machine learning model may include at least one of: a boosted decision tree; a generalized additive model for location, scale and shape; a distributional random forest; and a deep ensemble including a plurality of neural networks.

The non-transitory computer-readable medium may further store instructions that, when executed by the computer system, cause the computer system to receive a plurality of offer acceptances in response to the plurality of financial offers, where the portfolio of assets includes accepted financial offers. An offer acceptance of the plurality of offer acceptance may correspond to a transfer of the offer size corresponding to the accepted financial offer to an account associated with a merchant, and the offer acceptance may result in a periodic automatic deduction of a withholding amount from the account associated with the merchant, the withholding amount being computed based on a withholding rate and a revenue of the merchant during a corresponding period.

The features of the machine learning model may include transaction volumes and merchant customer activities such as transaction interactions between a merchant with its customers.

The machine learning model may be trained based on training transactional data and training growth ratios of merchants.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A method comprising:
receiving a target yield rate constraint, a target loss rate constraint, and target repayment time constraint for a portfolio of assets;
receiving historical transaction data for each corresponding merchant of a plurality of merchants, the historical transaction data being collected by a transaction processing platform;
computing, using a machine learning model executed by a computer system comprising a processing circuit, parameters of an implied growth ratio distribution for each corresponding merchant of the plurality of merchants based on features of the corresponding historical transaction data;
identifying, by the computer system, a plurality of financial offers to be made to the plurality of merchants based on the corresponding implied growth ratio distributions, subject to the target yield rate constraint, the target loss rate constraint, and the target repayment time constraint, based on:
a first optimization based on the target yield rate constraint and backtesting on the target loss rate constraint and the target repayment time constraint;
a second optimization based on the target loss rate constraint and backtesting on the target yield rate constraint and the target repayment time constraint; and
identifying an offer size and offer premium for each of the plurality of financial offers based on the corresponding implied growth ratio distribution, the first optimization, and the second optimization; and
transmitting the plurality of financial offers to corresponding ones of the plurality of merchants to construct the portfolio of assets.

2. The method of claim 1, wherein the computing the plurality of financial offers comprises:
performing a third optimization based on the target loss rate constraint and backtesting on the target yield rate constraint and the target repayment time constraint.

3. The method of claim 1, further comprising receiving a plurality of offer acceptances in response to the plurality of financial offers, where the portfolio of assets comprises accepted financial offers.

4. The method of claim 3, wherein an offer acceptance of the plurality of offer acceptance corresponds to a transfer of the offer size corresponding to the accepted financial offer to an account associated with a merchant.

5. The method of claim 4, wherein the offer acceptance results in a periodic automatic deduction of a withholding amount from the account associated with the merchant, the withholding amount being computed based on a withholding rate and a revenue of the merchant during a corresponding period.

6. The method of claim 1, wherein the machine learning model is trained based on training transactional data and training growth ratios of merchants.

7. The method of claim 1, wherein the identifying the offer size and the offer premium of each of the plurality of financial offers comprises:
retrieving growth ratios from a lookup table based on the parameters of the implied growth ratio distribution for the corresponding merchant, the lookup table being computed by constructing a grid of growth ratios in accordance with the first optimization and the second optimization; and
performing linear interpolation on the growth ratios retrieved from the lookup table.

8. The method of claim 1, wherein a training process training the machine learning model comprises:
extracting, based on training historical transaction data for each of a plurality of training merchants, a plurality of input features for a training merchant of the training merchants and a historical transaction volume growth rate; and
computing a probabilistic model based on the plurality of input features and the historical transaction volume growth rate, the probabilistic model being configured to output a distribution of implied transaction volume growth rates for a merchant described by the plurality of input features.

9. The method of claim 8, wherein the training historical transaction data is collected by the transaction processing platform.

10. A method comprising:
extracting, based on historical transaction data for each of a plurality of training merchants, a plurality of input features for a training merchant of the training merchants; and a historical transaction volume growth rate; and
training a machine learning model based on the plurality of input features and the historical transaction volume growth rate, the machine learning model being trained to output a distribution of implied transaction volume growth rates for a merchant described by the plurality of input features.

11. The method of claim 10, wherein the historical transaction data is collected by a transaction processing platform.

12. The method of claim 10, wherein the distribution of implied transaction growth rates has a distribution parameterized by a shape value and a scale value, wherein the distribution is selected from a group comprising:
a gamma distribution;
a lognormal distribution; and
a Weibull distribution.

13. The method of claim 10, wherein the machine learning model comprises at least one of:
a boosted decision tree;
a generalized additive model for location, scale and shape;
a distributional random forest; and
a deep ensemble comprising a plurality of neural networks.

14. A non-transitory computer-readable medium storing instructions that, when executed by a computer system comprising a processing circuit, cause the computer system to:
receive historical transaction data for each merchant of a plurality of merchants, the historical transaction data being collected by a transaction processing platform;
compute, using a machine learning model, parameters of an implied growth ratio distribution for each corresponding merchant of the plurality of merchants based on features of the corresponding historical transaction data;
identify an offer size and an offer premium for each financial offer of a plurality of financial offers to be made to corresponding ones of the plurality of merchants by looking up parameters in a lookup table based on the corresponding implied growth ratio distributions of the merchants, the lookup table being computed based on:
a first optimization based on a target yield rate constraint and backtesting on a target loss rate constraint and a target repayment time constraint; and
a second optimization based on the target loss rate constraint and backtesting on the target yield rate constraint and the target repayment time constraint; and
transmit the plurality of financial offers to the plurality of merchants.

15. The non-transitory computer-readable medium of claim 14, wherein the implied growth ratio distribution comprises a distribution selected from a group comprising:
a gamma distribution;
a lognormal distribution; and
a Weibull distribution, and
wherein the parameters comprise a shape value and a scale value.

16. The non-transitory computer-readable medium of claim 15, wherein the lookup table maps from the shape value and the scale value of the parameters of the implied growth ratio distribution to a growth ratio, and
wherein the offer size and the offer premium are computed based on the historical transaction data. the growth ratio, and an expected loss rate of the merchant.

17. The non-transitory computer-readable medium of claim 14, wherein the machine learning model comprises at least one of:
a boosted decision tree;
a generalized additive model for location, scale and shape;
a distributional random forest; and
a deep ensemble comprising a plurality of neural networks.

18. The non-transitory computer-readable medium of claim 14, further storing instructions that, when executed, cause the computer system to receive a plurality of offer acceptances in response to the plurality of financial offers, where the portfolio of assets comprises accepted financial offers.

19. The non-transitory computer-readable medium of claim 18, wherein an offer acceptance of the plurality of offer acceptance corresponds to a transfer of the offer size corresponding to the accepted financial offer to an account associated with a merchant, and
wherein the offer acceptance results in a periodic automatic deduction of a withholding amount from the account associated with the merchant, the withholding amount being computed based on a withholding rate and a revenue of the merchant during a corresponding period.

20. The non-transitory computer-readable medium of claim 14, wherein the machine learning model is trained based on training transactional data and training growth ratios of merchants.
